(19) United States
(12) Patent Application Publication
(10) Pub. No.: US 2018/0047114 A1
(43) Pub. Date: Feb. 15, 2018

(54) Synchronous Social Media Advertisement Using One or More Influencers

(71) Applicant: Vity Patent Holdco, LLC, Loveland, CO (US)

(72) Inventor: Lynne Haaland, Burbank, CA (US)

(21) Appl. No.: 15/675,728

(22) Filed: Aug. 12, 2017

Related U.S. Application Data
(60) Provisional application No. 62/374,358, filed on Aug. 12, 2016.

(51) Int. Cl. G06Q 50/00; G06Q 30/02

(52) U.S. Cl. CPC G06Q 50/01; G06Q 30/0242; G06Q 30/0264

(57) ABSTRACT

A social media advertisement system may coordinate the timing of social media posts. Such a system may cause several social media influencers to post in a coordinated fashion, such as all at a virtually the same time, or structured posts over a period of time. The influencers may be independent people who may each have a separate contract or other relationship with a social media advertisement system, and the system may recruit and manage the influencers, as well as identify the timing and schedule for an advertising campaign. Once the influencers may be organized, the system may trigger posts to be sent in a coordinated fashion.

### CROSS REFERENCE TO RELATED APPLICATIONS

This application claims benefit of and priority to U.S. Patent Application Ser. No. 62/374,358 entitled “Synchronous Social Media Advertisement Using One or More Influencers” by Lynne Haaland, filed 12 Aug. 2016, the entire contents of which are hereby expressly incorporated by reference for all it discloses and teaches.

### BACKGROUND

Influencers in social media are any participant that has a voice. A social media influencer might be a celebrity, a well-known author, politician, movie actor, or other well-known person. However, many people have gained notoriety and fame purely by building a following on social media.

Influencers may monetize their influence and fame by advertising or promoting different products or services. In some cases, the advertising or promotion may be paid advertising, while in other cases, the promotion may not be paid.

Advertisers may be brands who wish to promote their products, and may hire social media influencers as part of an advertising or marketing campaign. Because the social media influencers may typically be individual people, managing a campaign with multiple independent people may be difficult.

### SUMMARY

A social media advertisement system may coordinate the timing of social media posts. Such a system may cause several social media influencers to post in a coordinated fashion, such as all at a virtually the same time, or structured posts over a period of time. The influencers may be independent people who may each have a separate contract or other relationship with a social media advertisement system, and the system may recruit and manage the influencers, as well as identify the timing and schedule for an advertising campaign. Once the influencers may be organized, the system may trigger posts to be sent in a coordinated fashion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a synchronized advertisement system.

FIG. 2 is a diagram illustration of an embodiment showing a schematic or functional representation of a network with a synchronized advertisement system.

FIG. 3 is a flowchart illustration of an embodiment showing a method for setting up a synchronized advertisement campaign.

FIG. 4 is a flowchart illustration of an embodiment showing a method for estimating effectiveness of a synchronized advertisement campaign.

FIG. 5 is a flowchart illustration of an embodiment showing a method for operating a synchronized advertisement campaign.

### DETAILED DESCRIPTION

A social media influencer advertisement system may coordinate the activities of multiple influencers to create a coordinated advertisement campaign. By coordinating the efforts, an advertising campaign may have much more impact than a single influencer's actions. Coordinated activities may have an additive and sometimes multiplicative effect in spreading a message through social media. Coordinated activities may be useful in spreading a message to a consumer through multiple channels, thereby enhancing the consumer's awareness and increasing conversion of the consumer into a paying customer.

Influencers may be any person with a social media voice. Virtually everybody who participates in social media may have “followers,” which may be other users who receive a person's social media posts. Conventional social media influencers may be those participants with extraordinarily large numbers of followers. Some social media influencers may have tens of thousands, hundreds of thousands, or even millions of followers.

An advertisement system may recruit and manage influencers for a given campaign. Part of the campaign may be to transmit posts from multiple influencers in a synchronized or pre-determined timing. Many social media platforms may track “trending” topics, where the number of people discussing a topic, post, or other factor may be highlighted. Such trending topics may help someone browsing the social media platform to determine what the larger group of people may be discussing.

By synchronizing the posts of multiple people, an advertising campaign may attempt to raise a topic to member's awareness. Raising awareness may come in multiple forms. For example, one way to raise awareness may be to expose a person to an advertising campaign several times and from several different sources. Such a mechanism may expose a user to the same or similar advertising message from multiple people on a social media platform. Such messaging may seem more meaningful and possibly more authentic when received from different sources.

Another way to raise awareness may be to elevate the advertiser's message to a higher priority within the social media platform. Messages, topics, posts, subjects, or other content may be prioritized within a user's social media feed. Such content may be prioritized because other users of the platform are discussing or interacting with the content.

In many cases, a trending topic may be recognized based on how many people interacted with the topic. An interaction may be actually viewing a topic, but other interactions may be more heavily weighted. Examples of other interactions include forwarding or sending a post about the topic to another person, expressing an opinion about the topic, clicking on a Uniform Resource Identifier related to the topic, or any other interaction where the recipient takes an affirmative action.

By coordinating the activities of multiple influencers on a social media platform, an advertising campaign may become prioritized in the platform and may then be promoted by the platform itself. Such a situation may have the benefit of using a social media platform's prioritization algorithms or techniques to dramatically multiply the exposure of the advertiser's message.

The system may coordinate a campaign by designating the timing or sequencing of a campaign across multiple influencers. A campaign may include a single time when a group of influencers may post content relating to the campaign. An example may be to have a dozen influencers post an advertisement around noon on a certain day. The influencers may agree to the campaign ahead of time, then may be given content that they may post at the defined time. In some cases, the system may schedule a post in the influencer's queue, or the system may actually transmit the post to the social media platform using the influencer's account.

One form of the campaign may have posts scheduled over a period of time, where the posts may come from multiple influencers. For example, a subset of influencers may begin a campaign on Monday, a second subset of influencers may begin posting on Tuesday, and so on through the week. By the end of the week, a large number of influencers may be posting as part of the campaign.

Organizing the influencers prior to a campaign may involve identifying potential influencers, offering the influencers an opportunity to join the campaign, determining whether the influencer has availability to participate in the campaign, then implementing the campaign by causing the posts to be made in a desired timeframe.

Many influencers may operate as independent entities. In some cases, influencers may be represented by agents, and in some cases, groups of influencers may be commonly represented or may even operate as an organized group of influencers.

Throughout this specification and claims, the term “influencer” may be any person who may have a social media presence. In some cases, an influencer may have a small number of followers, while in other cases, an influencer may have millions of followers. Conventionally, a social media influencer may be a single person, although some social media platforms may allow for a single person, company, or organization to have multiple accounts, where each social media account may be considered an influencer.

Throughout this specification and claims, the term “post” may be any transmission that a social media influencer may make to a social media platform. A post may be text-based, video, audio, or have any other media content. In some cases, the post may be generated by the influencer, while in other cases, a post may be partially or fully created by someone else. In many cases, a post may contain a link, often in the form of a Uniform Resource Identifier (URI), that may cause a device to retrieve and display information from the Internet or some other location. Such links may be a mechanism to track whether a follower actually engaged with the influencer's posts.

The term “follower” may be a person who is capable of receiving a transmission from a social media platform. A follower may subscribe to the posts of an influencer, and when a follower views their social media account, the follower may be exposed to the post of the influencer.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. When the subject matter is embodied in “non-transitory” media, the media may be any storage media that expressly does not include live signals.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

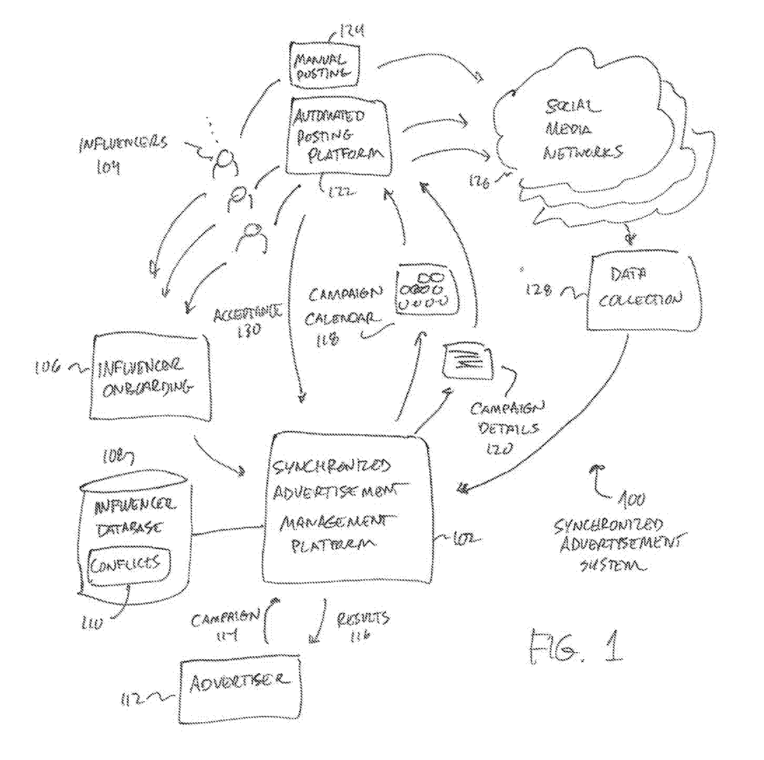

FIG. 1 is a diagram illustration of an embodiment 100 showing a system for a synchronized advertisement system. Embodiment 100 is merely one example of various interactions that may occur to synchronize or organize multiple influencers into an advertising campaign.

A synchronized advertisement management platform 102 may manage multiple influencers 104 into a single advertisement campaign. The organized campaign may have multiple influencers posting at the same time, or may have a sequential organization of posts. The system may take individual influencers 104 and cause the influencers 104 to behave in an organized fashion.

Organizing influencers can be a difficult problem. In many cases, social media influencers may be independent people who may not operate through an agent or other organization. As such, coordinating the activities of the influencers may be solved by automating or assisting in posting for each influencer.

An organized advertising campaign may attempt to take advantage of the sharing nature of social media platforms. Such platforms may highlight topics or posts that may have a higher likelihood of being shared or generating user interaction. In many cases, a social media platform may attempt to provide relevant content to users. One mechanism for determining relevance to a user may be that the content was enjoyed by another similar user. In the case of paid advertisements, many online platforms may highlight or promote content that may be more likely to generate interactions.

An organized advertising campaign may attempt to increase the relevance of a topic by generating a large amount of activity on a social media platform for the topic. Many social media platforms may have relevance algorithms that correlate activity with relevance. Further, many such platforms may value the diversity of sources of the activity. For example, a single influencer who posts 100 times about a topic may be less relevant than 100 individual influencers who post one time on the same topic. In such systems, the wider the group of influencers, the more relevance a topic may have.

Once a topic gains relevance, a social media platform may begin showing the relevant topic to more and more users who may not have initially been exposed to the original set of posts that may have started the topic. When these second set of users also interact with the topic, the topic may be further reinforced and may further propagate. In this manner, the advertised topic may self-propagate throughout the social media platform. Such an occurrence may be known as “going viral” in the parlance of social media.

The organization of multiple influencers may involve recruiting the influencers for a particular campaign, vetting the influencers both for conflicts as well as schedule availability, and causing posts to go out at a predetermined time. Additionally, a campaign may monitor effectiveness by tracking actions taken by influencers, followers, and other users during the campaign.

Influencers 104 may go through an onboarding mechanism 106 to join the synchronized advertisement management platform 102. The onboarding mechanism 106 may include adding details about the influencer, such as their name, address, payment mechanism, and other administrative details. The onboarding mechanism 106 may further include determining the influencer's following and analyzing various metrics about the following. For example, a demographic profile of the influencer's following may be generated, which may be used to match candidate influencers for a particular advertising campaign.

The onboarding mechanism 106 may add the influencer to an influencer database 108. In many cases, an influencer's conflicts 110 may be determined. A conflict may be any previous advertisement, promotion, or affinity for specific topics, brands, or other information that may cause a conflict with a particular advertiser. For example, a previous promotion of one soft drink company may be a conflict for an influencer when a second soft drink company may be considering a campaign.

In some cases, a conflict database may include topical, philosophical, political, or other information. Such information may prevent an influencer who may have expressed religious beliefs from being considered for campaigns that may conflict with those beliefs.

An advertiser 112 may create a campaign 114 with the synchronized advertisement management platform 102. The campaign definition may include the topic of the campaign, a proposed sequence and timing of posts, and demographic profiles of a target audience. In some cases, a campaign definition may include requested influencers.

The platform 102 may attempt to match the campaign 114 with an inventory to influencers from the influencer database 108. Candidate influencers may be selected based on demographic profile and other factors. In some cases, candidate influencers may be identified by analyzing an influencer's calendar of future posts.

Many influencers 104 may use automated posting platforms 122, which may schedule future posts. Such platforms may be queried with a campaign calendar 118 to determine whether an influencer 104 may have inventory of posts that may be allocated for a proposed campaign.

Many influencers 104 may have predefined goals for posting, such as number of posts, topics for the posts, and other goals. In many cases, an influencer 104 may have an inventory of posting slots that may be available for advertising campaigns. A synchronized advertisement management system 102 may evaluate an influencer's available inventory and determine if sufficient inventory may be available for a given campaign.

An analysis of posting inventory may involve determining whether or not an influencer has available time slots for posting as part of a campaign. The analysis may compare a proposed campaign time slot with any pre-planned post. In some cases, the analysis may be as simple as determining that an influencer does not have a post planned for a requested time slot. In other cases, an analysis may evaluate an influencer's historical posting pattern to determine if the influencer often posts at the requested time. Such analysis may avoid posting at an unexpected time.

Influencers 104 may be given an option to participate in a campaign. The influencers 104 may receive a campaign calendar 118 and various campaign details 120, and the influencers 104 may indicate acceptance 130 of the terms of the campaign. In some cases, an influencer 104 may manually evaluate and accept each campaign.

An influencer 104 may define a set of parameters for which they would accept a campaign. Such a set of parameters may include the price for which the influencer would be paid, the categories of acceptable advertisements, and other sets of parameters. When the set of parameters may be met by a campaign, the acceptance may be automatically made.

Once acceptance 130 is made by enough influencers 104 for a given campaign, the campaign may be launched. At launch, each influencer 104 may be given a set of campaign collateral. Campaign collateral may include images, product samples, audio or video clips, suggested text for posting, or other collateral with which an influencer may create posts. In some cases, the campaign posts may be predefined, where the influencer may have little or no control over the content of the posts. In other cases, an influencer may have full or limited creative control of the posts that they may make for a campaign.

The posts may be made on various social media networks 126. Some campaigns may focus on one social media network, while other campaigns may use multiple social media networks 126.

Campaigns may often have tracking mechanisms for posts. The tracking mechanisms may be a simple as hashtags that may be used for the campaign, while other tracking mechanisms may include customized Uniform Resource Indicators, tracking pixels, or other mechanisms by which activities may be tracked in a social media network.

As a campaign progresses, a data collector 128 may collect and correlate available tracking data. The data collector 128 may be used to generate results 116 that may be sent to the advertiser 112. In other uses, the data may be made available to influencers 104 so that the influencers 104 may know how well they performed individually or as a group.

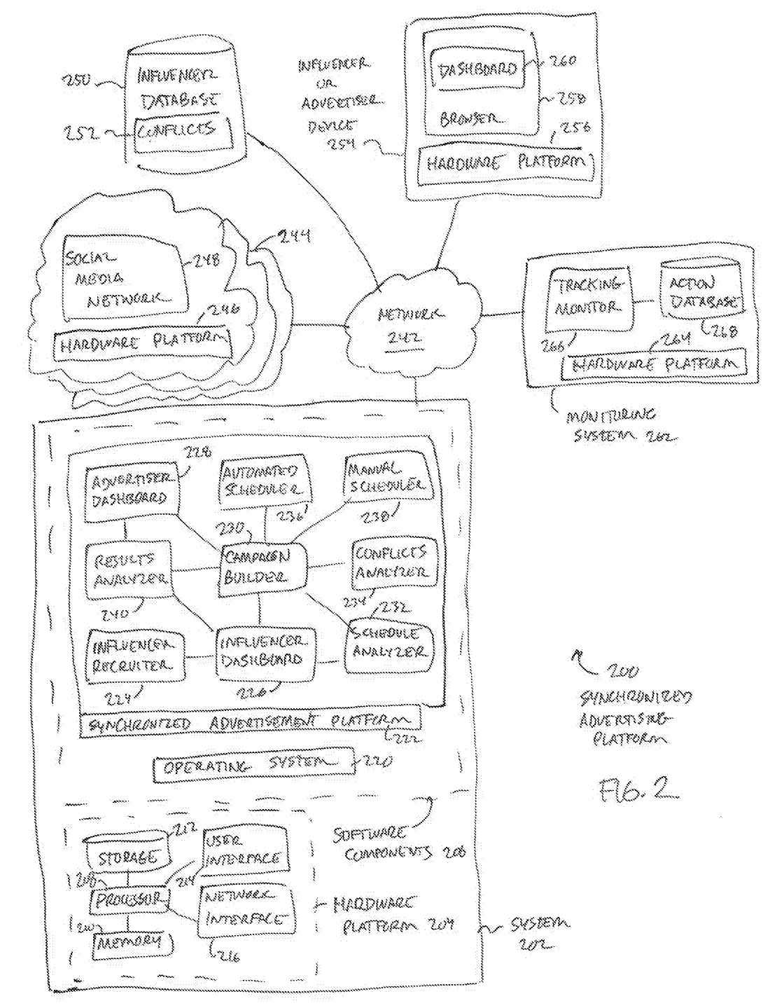

FIG. 2 is a diagram of an embodiment 200 showing components that may manage influencer advertising campaigns. The components are illustrated as being connected across a network 242.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a system 202 that may have a hardware platform 204 and various software components. The system 202 as illustrated represents a conventional computing device, although other embodiments may have different configurations, architectures, or components.

In many embodiments, the system 202 may be a server computer. In some embodiments, the system 202 may still also be a desktop computer, laptop computer, netbook computer, tablet or slate computer, wireless handset, cellular telephone, game console or any other type of computing device. In some embodiments, the system 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A synchronized advertisement platform 222 is illustrated as operating on a single hardware platform 204. In other embodiments, various components or portions of components of the synchronized advertisement platform 222 may be implanted on separate hardware platforms.

The synchronized advertisement platform 222 may contain various components that may create a group of influencers, then cause one or more posts to occur in a synchronized or coordinated fashion between the influencers.

An influencer recruiter 224 may be a mechanism by which new influencers may be added to a database of available influencers. The database of influencers may be then used to put together a group of influencers for a campaign. The influencer recruiter 224 may collect various information about an influencer, including the influencer's preferences for the type of campaign the influencer may wish to join.

An influencer may provide an influencer recruiter 224 with information about the influencer's social media accounts. Such information may be used to collect demographic and other information about the influencer's followers. An influencer recruiter 224 may be a series of user interfaces through which an influencer may register to receive requests for various campaigns. In some cases, a system may operate by first establishing relationships with influencers, then sending a campaign request to those influencers who have previously registered. In other cases, a system may have several campaigns and influencers may sign up in response to the campaign. Still other versions may operate with a combination of such approaches.

Some systems may make influencer profiles available to advertisers prior to creating a campaign. In such cases, an advertiser may be able to select potential influencers for their campaign, and the potential influencers may receive invitations to participate in a campaign.

Some systems may make campaign profiles available to influencers prior to the influencer joining the system. In such cases, an influencer may be able to view some information about the available campaigns, then may join the system and may learn additional information about available campaigns.

The influencer recruiter 224 may include collecting information about specific types of campaigns that the influencer wishes to avoid or wishes to join. Data about the influencer may be stored in an influencer database 250. An influencer may have a set of constraints or conflicts 252 that may limit the types of campaigns or advertisers. A conflict may be any constraint that may prohibit an influencer from joining a campaign. Examples of conflicts may be previous advertisers for which the influencer may have worked, as well as personal preferences for or against any specific advertiser, types of advertisement, types of products or services being advertised, or any other constraint. Such conflicts may be added through the influencer recruiter 224 or may be updated, added, or edited over time.

An influencer dashboard 226 may be a user interface through which an influencer may interact with the system. In some cases, the influencer dashboard 226 may be a web page accessible to influencers who have registered on the system. The influencer dashboard 226 may have administrative functions such as allowing the influencer to update, add, delete, or otherwise modify their data in the system.

The influencer dashboard 226 may include mechanisms by which an influencer may interact with potential campaigns. For example, an influencer may be able to browse campaigns and evaluate various parameters about the campaigns, such as the timing and number of requested posts, payment terms, and other parameters. The influencer may request to join a campaign, and such a request may be sent to an advertiser for approval.

The influencer dashboard 226 may include mechanisms by which an advertiser may request that an influencer participate in a campaign. An advertiser may select the specific influencer, and the request may be displayed on the influencer dashboard 226. In some situations, the influencer may accept the terms of the campaign, while in other situations, the influencer may be able to reject certain terms or suggest new terms. When an influencer may change the terms of an engagement, a negotiation procedure may occur between the influencer and the advertiser for the campaign. Some systems may not facilitate negotiations.

The influencer dashboard 226 may show the influencer's performance. The performance may be a record of their previous or ongoing campaigns, including any payments that the influencer has received or may be owed. Some systems may include performance metrics for campaigns, such as conversions, click through rate, re-posting rate, number of views, and other parameters.

An advertiser dashboard 228 may be a user interface through which an advertiser may interact with the system. In some cases, such a mechanism may be a web page or other user interface. The advertiser dashboard 228 may include administrative mechanisms for establishing and modifying an account, determining methods of payment, and other particulars.

An advertiser dashboard 228 may include mechanisms for establishing and managing campaigns. Such mechanisms may include user interfaces through which a new campaign may be created, such as defining the topics, timing, uploading advertisement collateral, payments and budgets, and any other information that may be used in creating a campaign. In some cases, the campaign may be made available to influencers. Many such systems may make a larger set of campaign details available to registered influencers, and some systems may have a limited description of the campaign available to unregistered influencers or the general public.

The advertiser dashboard 228 may include mechanisms for finding and selecting influencers for a campaign. Some systems may have a mechanism by which an advertiser may browse influencers and select influencer who may participate in a campaign. An advertiser may be able to send a participation request to the selected influencers, who may join the campaign. Some systems may have a negotiation feature whereby an advertiser and influencer may negotiate various terms of a campaign.

The advertiser dashboard 228 may include mechanisms for monitoring a campaign. The monitoring features may include campaign metrics and statistics that may be updated from time to time. The monitoring features may include number of posts, responses to the posts, conversion rates, and any other parameter. In some cases, a system may allow an advertiser to update or change elements of a campaign as the campaign progresses. For example, an advertiser may be able to add or remove influencers, increase or decrease the budget, increase or decrease the posts, add or remove advertising collateral, or other changes to the campaign.

A campaign manager 230 may construct, deploy, and manage advertising campaigns. During the construction phase, the campaign manager 230 may assemble an advertising campaign by receiving campaign information from an advertiser, assembling and scheduling the influencers, distributing campaign collateral, and preparing the campaign to launch. During deployment, the campaign manager 230 may prepare tracking information and schedule the campaign posts. During the management phase, the campaign manager 230 may monitor the activities of the campaign, generate statistics and various reports, and may receive updates and changes to the campaign from advertisers and influencers.

Prior to launching the campaign, a campaign manager 230 may assemble the campaign information and establish the relationships that will occur during the campaign. Such a phase may involve analyzing influencer's schedules using a schedule analyzer 232 to determine which influencers have inventory of available posts that corresponds with the campaign.

A schedule analyzer 232 may access an influencer's editorial calendar to determine whether a campaign would be suitable for the influencer. In many cases, an influencer may use an automated posting system, which may automatically post content at predetermined times. Such systems may operate by defining the post and its content, then setting a time to transmit the post to a social media network. The schedule analyzer 232 may analyze such scheduled posts and determine whether the influencer has inventory of available time slots that may match the campaign.

A schedule analyzer 232 may access previous posts of an influencer to determine whether a specific future time for a post may be appropriate or available. For example, an influencer who generally posts in the evening or at night may not generally post in the morning. By analyzing an influencer's posting history, a schedule analyzer 232 may determine that the campaign's morning timeslot may be inappropriate for the influencer.

A conflicts analyzer 234 may determine if an influencer's prior history or preference may preclude having the influencer participate in a given campaign. The conflicts analyzer 234 may match the campaign advertiser against any previous advertisers who may have hired the influencer before, and may determine whether or not the previous advertisers may pose a conflict for the current advertisers. An influencer may also define a set of campaign parameters for which the influencer may prefer to participate, as well as a set of campaign parameters for which the influencer may wish to be excluded.

After assembling the campaign and preparing the campaign for launch, a campaign builder may use an automated scheduler 236 or manual scheduler 238. An automated scheduler 236 may communicate with a social media network and may send posts on behalf of an influencer. In many cases, automated schedulers may keep a calendar of scheduled posts, and a campaign builder 230 may transmit campaign posts to the automated scheduler 236 for posting. Such a system may be useful for influencers who may forget or may not be available exactly at the time a campaign posting may be requested.

A manual scheduler 238 may be a system that reminds an influencer to post at a given time. Such a system may send a text message, email message, direct message, or some other message to the influencer to remind the influencer to send a post. In many cases, a system may transmit a pre-written post that may include collateral, such as images, audio clips, video clips, or other collateral that may assist the influencer in generating a post. In some cases, the influencer may post using the recommended wording and collateral, and in other cases, the influencer may customize or completely rewrite the post before sending.

A results analyzer 240 may track the performance of a campaign and generate statistics that may be displayed on the advertiser dashboard 228, the influencer dashboard 226, or in some other fashion. The results analyzer 240 may track various metrics, such as when the posts were made, the viewership and reach of the post, the interactions that users had with the post, the conversions that resulted from the post, and may other metrics.

The network 242 may represent any type of communications network by which various devices and services may interact.

A group of social media networks 244 may be accessed over the network 242. Some campaigns may operate on one social network, while other campaigns may operate on several social networks. A social network 244 may have a hardware platform 246 on which a social media network 248 may operate.

An influencer or advertiser device 254 may represent a desktop computer, mobile phone, or other hardware device by which an influencer or advertiser may access the system 202. Such a device may have a hardware platform 256 on which a browser 258 may execute. The browser 258 may render a dashboard 260 that may be generated by the system 202.

A monitoring system 262 may be a tracking system that gathers events relating to a campaign and logs the events. Such a system may have a hardware platform 264 on which a tracking monitor 266 may identify actions in the campaign, including actions taken in one of the social media networks 244. The actions may be logged into an action database 268 for analysis by a results analyzer 240 or other system.

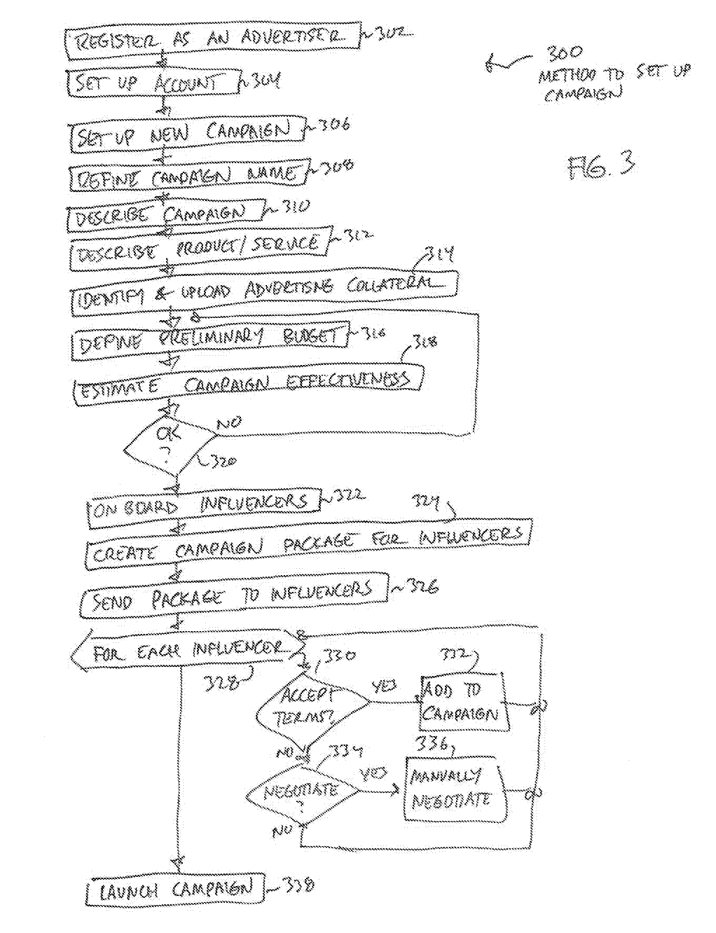

FIG. 3 is a flowchart illustration of an embodiment 300 showing a method to set up a campaign. The method illustrates one set of operations that may be performed by a synchronized advertising platform to prepare a campaign.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

An advertiser may register in block 302 and set up an account in block 304. The registration process may establish the advertiser as an authorized user as well as enter various information about the advertiser, including method of payment and other particulars.

The process of setting up a new campaign may begin in block 306. The campaign name may be entered in block 308, as well as a description of the campaign in block 310 and the product or service around which the advertising campaign may be centered in block 312. These pieces of data may be used within the system to attract influencers to the campaign. In some cases, a detailed version may be available to registered influencers, where the influencers may be able to browse campaigns and make themselves available to participate. In some cases, a scaled down version of the campaign information may be publicly available, which may be used to attract influencers to establish an account and learn more about how they may participate. Some systems may not reveal the company name and product to an influencer until an advertiser may have approved the influencer for a specific campaign.

Advertising collateral may be identified and uploaded in block 314. The advertising collateral may be sample posts, images, audio, video, or other media that may be compulsory or optional for the campaign. In many cases, an advertiser may permit an influencer to personalize their posts or other content. The advertising collateral may include tracking mechanisms, such as tracking pixels, hashtags, customized Uniform Resource Identifiers, or other tracking information.

A campaign budget may be established in block 316 and an analysis may be performed in block 318 to estimate the campaign effectiveness. If the effectiveness goals are not achieved in block 320, the process may return to block 316 to update the budget.

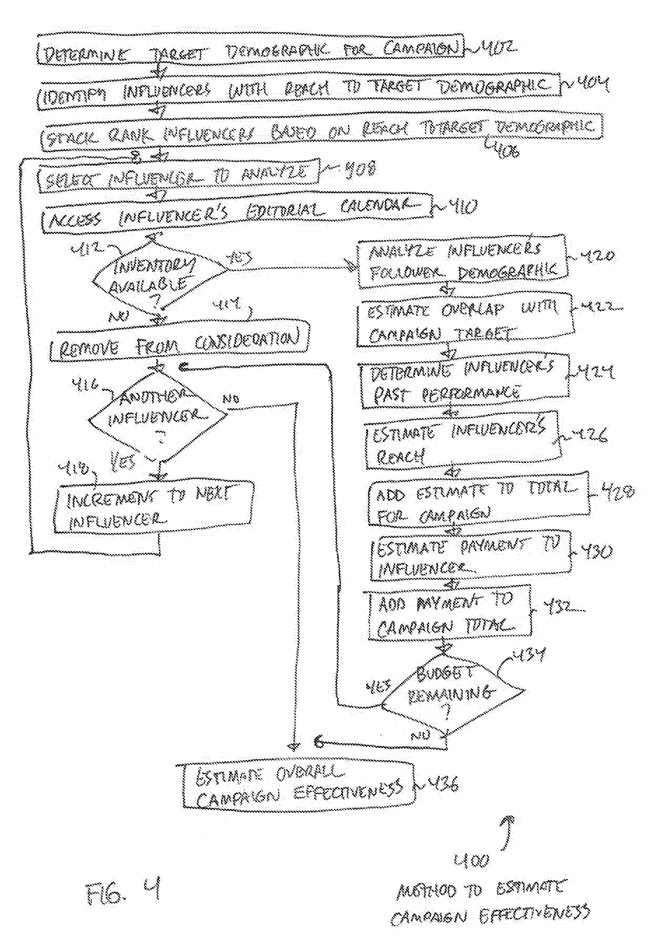

A detailed explanation of one method to do the analysis of block 318 may be illustrated in FIG. 4.

Once the estimated effectiveness of the campaign may be agreeable in block 320, a process of onboarding influencers may be performed in block 322. The onboarding process of block

Campaign packages may be prepared in block 324 and sent to influencers in block 326. The campaign packages may include proposed payments and other terms and conditions. For each influencer in block 328, if the influencer accepts the terms in block 330, they may be added to the campaign in block 332. If the influencer rejects the terms in block 330 but wishes to negotiate in block 334, a manual negotiation process may be performed in block 336.

In some cases, an influencer may be predefined conditions to which the influencer agrees to participate in a given campaign. When such conditions may be met by the advertiser, the influencer may be automatically enrolled in a campaign. With such a system, an advertiser may be able to deploy a campaign in minutes or even seconds.

After each influencer has been contacted and those that agree are added to the campaign in block 328, the campaign may be launched in block 338.

FIG. 4 is a flowchart illustration of an embodiment 400 showing a method to estimate campaign effectiveness. The campaign effectiveness may quickly help evaluate whether a given campaign may be worth pursuing or not.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process of embodiment 400 may evaluate a proposed campaign to determine how effective the campaign may be. The process may be automated such that a proposed campaign may be evaluated and implemented quickly.

A targeted demographic may be determined for the campaign in block 402. The demographic may include descriptions of the type of person the campaign may be targeted to reach. Influencers who have followers in the targeted demographic may be identified in block 404, and the influencers may be stack ranked or sorted based on the largest number of the targeted demographic.

In many cases, an influencer may have a very wide reach as given by a large number of followers, but the influencer may have limited reach into a desired demographic. For example, an influencer may have a very large number of followers, but few in a targeted demographic, which may be mothers between ages 25 to 30. Such an influencer may be only marginally valuable to a campaign because their reach, although large, may not cover the target for the campaign.

The influencers may be analyzed individually beginning in block 408, starting with the influencer with the largest reach into the targeted demographic.

The influencer's editorial calendar may be accessed in block 410 to determine available inventory. In many cases, influencers may use automated posting platforms that may schedule posts in advance, and the automated platforms may automatically send the posts to a social media platform on the influencer's behalf. When an influencer may not use an automated posting platform, the influencer's previous posts may be analyzed to determine whether the influencer may be likely to have available inventory.

If the influencer does not have available posting inventory in block 412, the influencer may be removed from consideration in block 414. If there are other influencers who have not yet been analyzed in block 416, the next influencer may be selected in block 418 and the process may return to block 408.

When the influencer has inventory available in block 412, the influencer's follower demographic may be analyzed in block 420 and the overlap between the influencer's followers and the target demographic may be determined in block 422. The overlap may represent the desired group of people that the influencer may be capable of reaching for the campaign. In many cases, the influencer's access to the target demographic may be a subset of the total number of followers, and the followers may span large demographics.

The influencer's past performance may be analyzed in block 424. The past performance may be a metric for how well did the influencer reach their overall group of followers. When the data may be available, the influencer's past performance may be calculated for the campaign demographic. When the influencer's past performance may not be known, a typical performance metric may be estimated based on other similar influencers.

The influencer's past performance may be a metric that defines how well the influencer's advertisements may connect with a demographic. The performance metric may be number of impressions, conversions, or other performance indicator.

The performance metric and the influencer's access to the campaign demographic may be used to estimate the influencer's expected reach for the campaign in block 426. The expected reach may be added to a cumulative total for the campaign in block 428.

The payment for the influencer may be estimated in block 430. In some cases, the payment may be based on a predetermined schedule that the influencer or the advertiser may set. In some cases, the influencer may be paid using a formula based on the influencer's reach, the influencer's performance, or some other metrics. The total payments to all the influencers analyzed so far may be summed in block 432. If the campaign budget may be greater than the total payments made to date, the process may return to block 416 to process another influencer.

If the budget has been met or exceeded in block 434 or there are no more influencers in block 416, the overall effectiveness of the campaign may be estimated in block 436. The overall effectiveness may be the sum of the estimated reach multiplied by the effectiveness of each influencer. In many cases, a “viral” factor may be applied for campaigns that have many posts from multiple influencers scheduled close together or in relationship to each other.

The viral factor may be a multiplier that may assume an increased performance based on the fact that many different influencers may be posting about a given topic at the same time. Such campaigns may have a viral effect by boosting the importance of the advertised topic by having multiple influencers post about the topic in a short period of time.

The overall effectiveness may be a metric that may help an advertiser determine if their campaign may be worth the investment. In some cases, an advertiser may increase their budget and re-run the analysis of embodiment 400 to increase the probability of success.

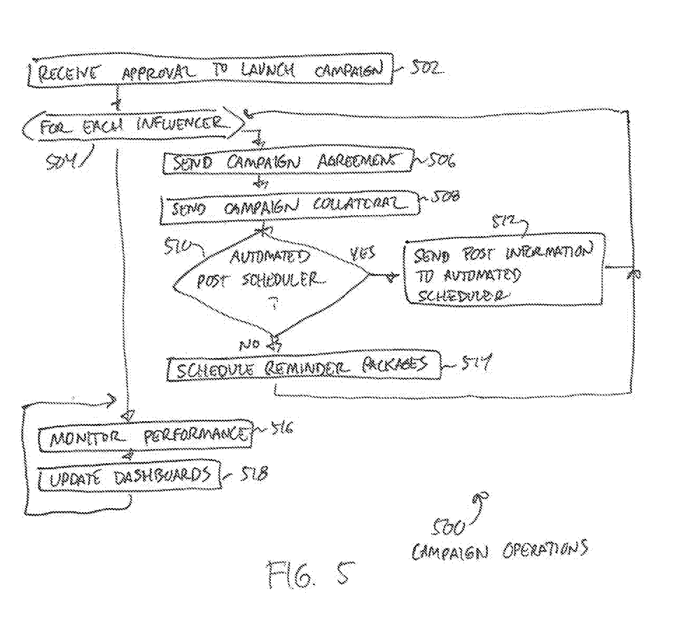

FIG. 5 is a flowchart illustration of an embodiment 500 showing a method to operate campaigns. Campaigns may operate by having influencers post at predetermined times. Many campaigns may have multiple influencers post at or near a given time, with an intent to cause a “viral” multiplier for the campaign. Some campaigns may also have multiple influencers post in sequence, such as having groups post every hour or every day. Such a continual posting schedule may cause the advertised topic to remain in user's minds as well as to be promoted within the social network.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Approval to launch a campaign may be given in block 502.

For each influencer in block 504, a campaign agreement may be sent in block 506 as well as campaign collateral in block 508. A campaign agreement may be any document that may confirm the terms and conditions of the campaign. In previous steps, the influencer may have already agreed to participate, and the campaign agreement of block 506 may be the final signed agreement. The campaign collateral may be posts, images, videos, sample text, hashtags, tracking mechanisms, Uniform Resource Identifiers, or any other information or collateral that an influencer may use in creating a post.

If an influencer has an automated post scheduler in block 510, the post information may be sent to the automated scheduler in block 512. In some cases, the influencer may be able to review, approve, update, change, or otherwise customize the posts prior to posting.

If no automated post scheduler exists for the influencer in block 510, reminder packages may be scheduled in block 514. A reminder package may be various campaign collateral, suggested post, or other information that may be transmitted to the influencer at or near the time that the campaign has scheduled a post for that influencer.

Once each influencer has been prepared in block 504, the posts may be posted at the appointed times. The system may monitor the campaign performance in block 516 and may update the various dashboards in block 518. The monitoring process may loop while the campaign executes, as well as for some time after completion to monitor any subsequent activity.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a hardware platform comprising at least one computer processor;
a synchronized advertisement management platform operating on said hardware platform, said synchronized advertisement management platform configured to:
determine a posting schedule for an advertising campaign, said posting schedule comprising timing for a plurality of posts being posted by a plurality of influencers;
identify said plurality of influencers; and
cause each of said plurality of influencers to post said plurality of posts according to said posting schedule.

2. The system of claim 1, said synchronized advertisement management platform further configured to:
search a first influencer's posting schedule to determine that said first influencer has posting inventory compatible with said advertising campaign; and
identify said first influencer as one of said plurality of influencers.

3. The system of claim 2, said posting inventory being accessed on a posting platform, said synchronized advertisement management platform further configured to:
transmit a query to a post management platform;
determine that a first post time is available for said advertising campaign; and
reserve said first post time for said advertising campaign.

4. The system of claim 3, said synchronized advertisement management platform further configured to:
determine a conflicts list for said advertising campaign, said conflicts list comprising a competitor to said advertising campaign;
identifying a second influencer and determining that said second influencer is not compatible with said conflicts list; and
not including said second influencer in said advertising campaign.

5. The system of claim 4, said posting schedule comprising posting on at least two different social media platforms.

6. The system of claim 1, said advertising campaign comprising a plurality of posts sent at a first predetermined time, each of said plurality of posts being sent by a different influencer.

7. The system of claim 1, said advertising campaign comprising a plurality of posts, each of said plurality of posts being sent in sequence, where each of said plurality of posts being sent by a different influencer.

8. The system of claim 7, at least one of said plurality of posts by a first influencer referencing an earlier post by a second influencer.

9. The system of claim 1, said synchronized advertisement management platform further configured to:
track a performance metric for each of said plurality of posts; and
display said performance metric for each of said plurality of posts.

10. The system of claim 1, said synchronized advertisement management platform further configured to identify said plurality of influencers by:
sending a request to each of said plurality of influencers for said advertising campaign, said request comprising at least a definition of posts and times for said posts to be made by each of said plurality of influencers; and
receiving a confirmation from each of said plurality of influencers.

11. A method performed by a computing system, said method comprising:
determining a posting schedule for an advertising campaign, said posting schedule comprising timing for a plurality of posts being posted by a plurality of influencers;
identifying said plurality of influencers; and
causing each of said plurality of influencers to post said plurality of posts according to said posting schedule.

12. The method of claim 11 further comprising:
searching a first influencer's posting schedule to determine that said first influencer has posting inventory compatible with said advertising campaign; and
identifying said first influencer as one of said plurality of influencers.

13. The method of claim 12 further comprising:
transmitting a query to a post management platform;
determining that a first post time is available for said advertising campaign; and
reserving said first post time for said advertising campaign.

14. The method of claim 13 further comprising:
determining a conflicts list for said advertising campaign, said conflicts list comprising a competitor to said advertising campaign;
identifying a second influencer and determining that said second influencer is not compatible with said conflicts list; and
not including said second influencer in said advertising campaign.

15. The method of claim 14, said posting schedule comprising posting on at least two different social media platforms.

16. The method of claim 11, said advertising campaign comprising a plurality of posts sent at a first predetermined time, each of said plurality of posts being sent by a different influencer.

17. The method of claim 11, said advertising campaign comprising a plurality of posts, each of said plurality of posts being sent in sequence, where each of said plurality of posts being sent by a different influencer.

18. The method of claim 17, at least one of said plurality of posts by a first influencer referencing an earlier post by a second influencer.

19. The method of claim 11 further comprising:
tracking a performance metric for each of said plurality of posts; and
displaying said performance metric for each of said plurality of posts.

20. The method of claim 11, said identifying said plurality of influencers being performed by:
sending a request to each of said plurality of influencers for said advertising campaign, said request comprising at least a definition of posts and times for said posts to be made by each of said plurality of influencers; and
receiving a confirmation from each of said plurality of influencers.
